(19) United States
(12) Patent Application Publication
(10) Pub. No.: US 2010/0268703 A1
(43) Pub. Date: Oct. 21, 2010

(54) METHOD OF SEARCH STRATEGY VISUALIZATION AND INTERACTION

(76) Inventor: Brian J. Buck, Lisle, IL (US)

Correspondence Address: SCHOX PLC, 500 3rd Street, Suite 515, San Francisco, CA, 94107, US

(21) Appl. No.: 12/425,784

(22) Filed: Apr. 17, 2009

(51) Int. Cl. G06F 17/30; G06F 3/048

(52) U.S. Cl. 707/713; 715/764; 707/E17.019; 707/E17.014

(57) ABSTRACT

A method for visually representing a search query that includes obtaining a desired search query, preparing a collection of search strategies for a query service, submitting the collection of search strategies to a query service, processing the search results, and displaying a visualization map of the search results that graphically represents the plurality of search strategies. The collection of search strategies is composed of a plurality of core search strategies for the desired search query and at least one combination of at least two core search strategies. The visualization map includes a plurality of graphical objects, and a graphical object represents a search strategy of the collection of query strategies.

### TECHNICAL FIELD

This invention relates generally to the computer search field, and more specifically to a new and useful visualization of search strategies in the computer search field.

### BACKGROUND

A computer or electronic search generally involves submitting a search query or string. More advanced methods are also possible from many query services or search engines. In an advanced mode a user can specify several additional terms, required terms, terms to exclude, file specifications like file type, wild card terms, and many other search strategies. These advanced search strategies exist so that a user can customize a search to obtain the desired results. When performing a wide search, a user may need to try many different search strategies to identify which search strategy works best for the current situation. Based on the number of basic strategies employed, there could be a large number of variations and combinations of search strategies to evaluate. Evaluating these search strategies, however, is often cumbersome and fraught with errors. Thus, there is a need in the computer search field to create a new and useful method of search strategy visualization and interaction. This invention provides such a new and useful method.

### BRIEF DESCRIPTION OF THE FIGURES

FIG. 1 is a flowchart of a first preferred embodiment of the invention;

FIG. 2 is a flowchart of a second preferred embodiment of the invention;

FIGS. 3A and 3B are a detailed views of variations of a visualization map;

FIGS. 4A and 4B are a detailed views of variations of a visualization map that depicts result data; and

FIG. 5 is a detailed view of a variation of a visualization map that has multiple selected search strategies.

FIGS. 6A, 6B, 6C, and 6D are variations of visualization maps with two, three, four and five dimensions of search strategies.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

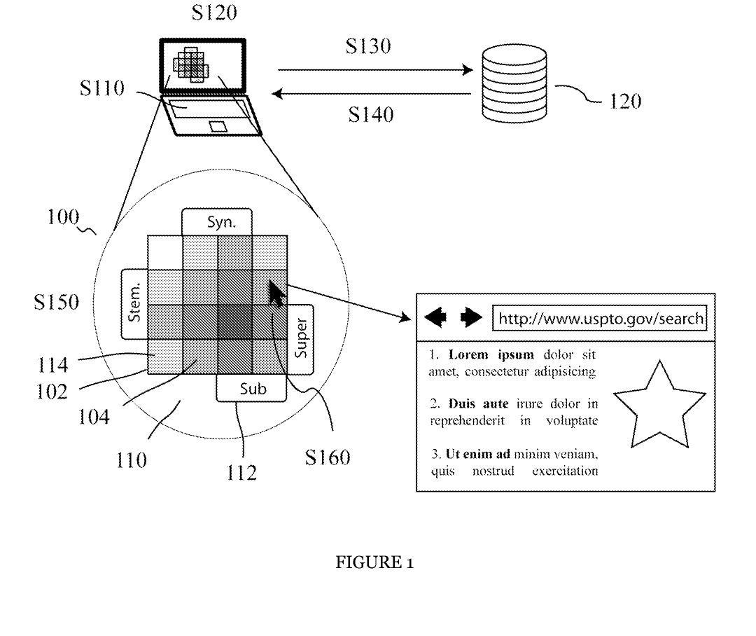

As shown in FIG. 1, the method of search strategy visualization and interaction includes the step of preparing a comprehensive collection of search strategies 110 that include a plurality of core search strategies 112 and one or more combinations of the core search strategies 112, and the step of displaying a visualization map 100 that graphically represents the comprehensive collection of search strategies 110. The method functions to allow a user to complete a wide variety of search strategies 114 and understand the impact of a search strategy 114. The method is preferably used in combination with, communication with, or in place of a query service 120. The query service 120 is preferably a consumer based Internet search engine (e.g., Google, Yahoo, etc.), an organized database (e.g. library system, government records, inventory list, etc.), and/or any suitable searchable electronic collection. The method is preferably implemented as a software application and/or a web application. The method may alternatively be implemented over any suitable computer system and/or network. In a first preferred embodiment the visualization is preferably used for feedback and as an interaction interface for returned search results. In a second preferred embodiment, the method is preferably used for query specification (selecting various search strategies). The method may alternatively be used in any suitable embodiment for any suitable application.

### 1. Search Result Visualization and Interaction

As shown in FIG. 1, the method of visually representing multiple search queries of the first preferred embodiment includes obtaining a desired search query S110, preparing a collection of search strategies for a query service S120, submitting the collection of search strategies to a query service S130, processing search results returned by the query service S140, and displaying a visualization map of the search results associated with the collection of search strategies S150. The first preferred embodiment functions to provide visual feedback on search results from the comprehensive collection of search strategies. The first preferred embodiment may additionally be used to provide interactive capability for the results of the comprehensive collection of search strategies

Step S110, which includes obtaining a desired search query, functions to gather the word or search query that a user or system wants to submit to a query service. The desired search query is preferably a word or phrase, but may alternatively be a selected search item, selected classification group, an advanced string (e.g. using Boolean operators or query service specific commands), combinations of search queries, and/or any suitable search that may be submitted to a query service 120. A user preferably enters the desired search query through a human computer interface such as a keyboard, mouse, and/or any suitable input device. A system may alternatively submit the desired search term. The step of obtaining a desired search query may additionally or alternatively include configuring one or more core search strategies. The configuration of the core search strategies 112 may include selecting a core search strategy, selecting options for a core search strategy, inputting information, and/or any suitable steps to setup a core search strategy. Alternatively, a search strategy may include a predicate involving one or more structured data fields.

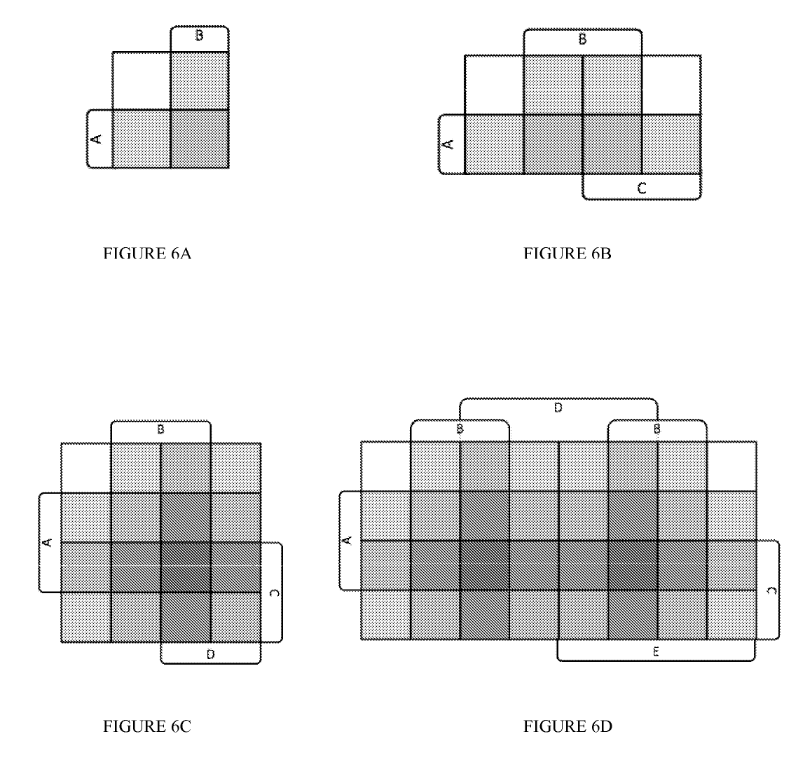

Step S120, which includes preparing a collection of query strategies for a search service, functions to create multiple variations and combinations of search strategies. The collection of search strategies 110 is preferably composed of a plurality of core search strategies 112 and at least one combination of the core search strategies 112. A search strategy 114 is preferably understood to be any term and/or command that may be submitted to a query service 120. A core search strategy 112 is preferably a variation of the desired search query. The core search strategy 112 preferably functions to either narrow or broaden a search query. The combination of core search strategies 112 functions to use two or more core search strategies 112 in cooperation to form a search strategy 114. The collection of search strategies 110 preferably includes the power set (every possible combination) of core search strategies 112. The collection of query strategies 110 may alternatively be a comprehensive collection (containing a majority of the possible combinations) or use any suitable number or arrangement of combinations of core search strategies 112. Four core search strategies 112 are preferably used, but any suitable number of core search strategies 112 may alternatively be used. As an example, the collection of query strategies may have four core search strategies 112 (represented by A, B, C, and D) based on the desired search strategy (S). In this example the collection of query strategies would include 16 search strategies: S, A, A+B, A+B+C, A+B+D, A+B+C+D, A+C, A+C+D, A+D, B, B+C, B+C+D, B+D, C, C+D, and D. As shown in FIGS. 6A, 6B, 6C, and 6D, two, three, four, five, and/or any suitable number of core search strategies may be used.

The core search strategies 112 are preferably a modification based on the desired search query, but the core search strategies 112 may be multiple desired search queries specified in substantially the same way as in Step S110. A core search strategy 112 may include variations on rules for the search query, modifying the parts of speech, appending wildcard characters, searching for only a portion of the desired search query, using hierarchical rules, and/or any suitable methods of modifying the desired search query. Alternatively, the core search strategy 112 may alternatively use Boolean logic with other search terms, be a specified range for a scalar quantity, be a different user or system specified desired search query, be a database field entry, be a specific query service to use, or any suitable modified search.

In one preferred embodiment the core search strategies 112 preferably include the core search strategies of stemming, synonyms, sub-concepts, and super-concepts. The stemming core search strategy preferably searches for words with the same root as a word from the desired search query. As an example, a desired search query of “compute” might include a stemming search for: computing, computed, computer, and computation. The synonyms core search strategy preferably searches for words that are defined synonyms of a word from the desired search query. Synonyms may alternatively be identified by using an ontological semantics lexicon and ontology. Ontological semantics (or OntoSem) is preferably understood to be a linguistic theory of the meaning of natural language. In this alternative, different words that have word senses that map onto the same particular concept in an ontology can be considered synonyms. As an example, a desired search query of “soil” might include a synonym search for: ground, dirt, and earth. The super-concepts core search strategy preferably searches for words that are hierarchically more abstract concepts (hypernymy/hyponymy) or that can be assemblies of parts or concepts from the desired search query. As an example, a desired search query of “beagle” might include a super-concept search for: hound, dog, canine, mammal, and animal. The sub-concepts core search strategy preferably searches for words/concepts linked from a particular word sense for a word. The desired search query or part of the desired search query is preferably an abstraction (or higher in a hierarchical sense) of the words/concepts of the sub-concepts search strategy. The sub-concepts core search strategy is preferably in the opposite hierarchical direction of a super concepts search strategy. As an example, a desired search query of “automobile” might include a sub-concepts search for: van, SUV, racecar, cab, bus, and Porsche. The super-concepts and sub-concepts core search strategies may additionally include a means to control the depth of a hierarchical search, or in other words, how many levels in a hierarchy the strategies can extend the search.

Step S130, which includes submitting the collection of search strategies 110 to a query service 120, functions to send the collection of search strategies to a query service 120 for executing a search. The collection of search strategies 110 is preferably submitted over a network or Internet to the query service 120. If multiple query services 120 are used, the collection of search strategies are preferably divided and sent to the corresponding query services 120. A computer application, web application, and/or any suitable portion of a computer system preferably performs the submission of the collection of query strategies.

Step S140, which includes processing search results returned by the query service 120, functions to collect and perform analysis on the search results returned by a query service 120. The processing preferably involves extracting search result data 104 such as the number of results, relevance of the results, or any suitable metric of the results. The processing may additionally or alternatively include collecting a sample or multiple samples of the results returned by the query service 120. The processing may alternatively include collecting all or a significant portion of the results. A processing algorithm may additionally or alternatively be used on the search results or portion of the search results for any suitable signal processing, aggregation of data, or any suitable purpose.

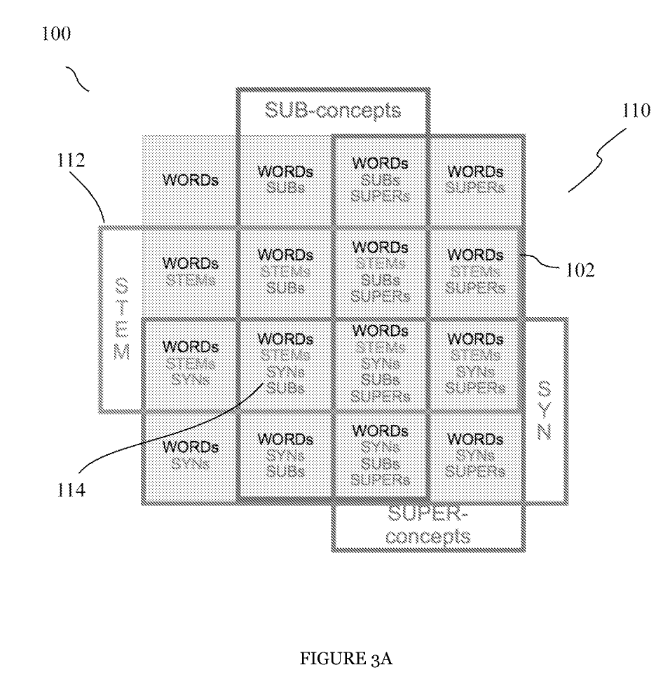

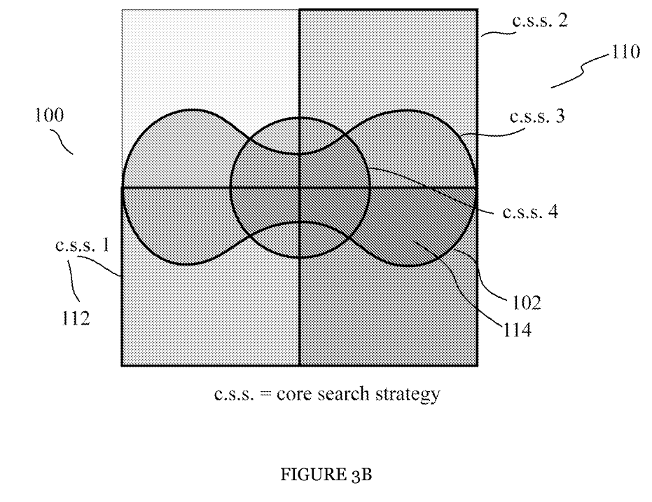

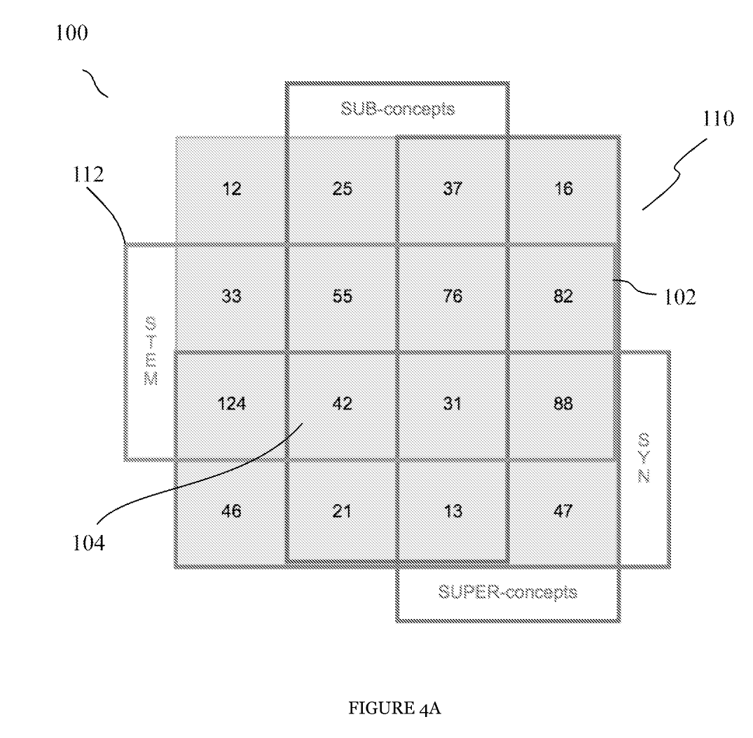

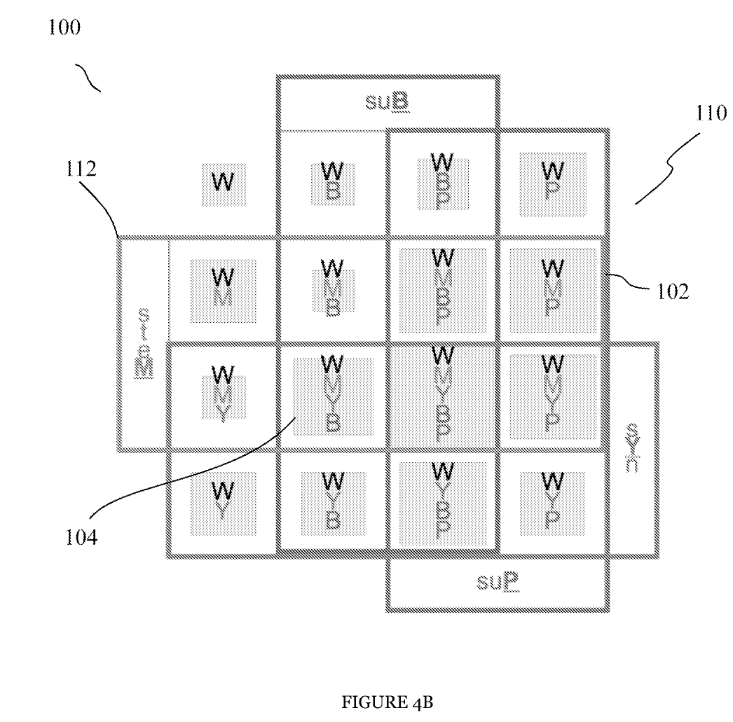

Step S150, which includes displaying a visualization map 100 of the search results, functions to graphically represent the results of the multiple search strategies 114. Step S140 additionally functions to convey visual information concerning the multiple search strategies. The visualization map 100 is preferably displayed on a computer screen, but may alternatively be printed, saved as a file, and/or any suitable action that eventually may be used for visual inspection. The visualization map 100 preferably presents search result data 104. The search result data 104 preferably includes how many search results each individual search strategy would receive, but alternatively, the visual map may convey relevancy of the results, number of unique results, quality of results, a pre-defined metric, and/or any suitable criteria for analyzing the results of a query service 120. The visualization map 100 preferably shows each individual search strategy as a defined graphical object 102 (such as a box, circle, image, etc.). The graphical object 102 preferably indicates the search result data 104 or part of the search result data 104 for the associated search strategy. The search result data 104 is preferably indicated by text, such as the number of results as shown in FIG. 4A, but may alternatively be indicated by size as shown in FIG. 4B (such as the size of the graphical object 102), color, shape, or any suitable symbolic or literal way. Each core search strategy 112 is preferably represented by a shape, and the overlapping sections of multiple shapes (that represent different core search strategies 112) preferably define the graphical objects 102 (that represent a search strategy that is a combination of core search strategies 112). This variation of a visualization map 100 functions to show the power set of combinations of core search strategies 112. The visualization map 100 is preferably organized in a manner substantially similar to a Karnaugh map used for digital logic optimization. A Karnaugh map is preferably used to show the power set of possible search strategies as seen in FIG. 3A. The core search strategies 112 are preferably used in place of the Boolean operators of a Karnaugh map. The boxes of a grid used in the Karnaugh map are preferably the graphical objects 102 indicating the plurality of search strategies 110. As an additional alternative, the core search strategies 112 may be shown as tabs extending from the Karnaugh map. The visualization map 100 may alternatively be organized as a Venn diagram as shown in FIG. 3B. The visualization map 100 may alternatively use a tree map, a linked lattice diagram, or any suitable representation of the search results from the collection of search strategies. The visualization map 100 may alternatively incorporate pictures, sounds, videos, text, webpages, and/or any suitable media associated with the search results. For example, when used with an image query service 120, previews of the images may be included within the graphical objects 102. The visualization map 100 may alternatively be arranged or displayed in any suitable manner.

As an additional alternative, the preferred method includes providing an interactive capability for a graphical object S160. Step S160 functions to allow a user to interact with visualization map 100. The interactive capability preferably provides access either by a link or display of additional information/media related to the search results. The interactive capability is preferably a link that is part of the graphical object 102 that will display the search results related to the search strategy of the graphical object 102. The interactive capability may alternatively allow the user to highlight and/or select multiple graphical object search strategies. A user is preferably able to view, combine, save, copy, download, remove, and/or perform any suitable computer operation on any search strategy by using the interactive capability of a graphical object 102.

### 2. Search Specification Visualization

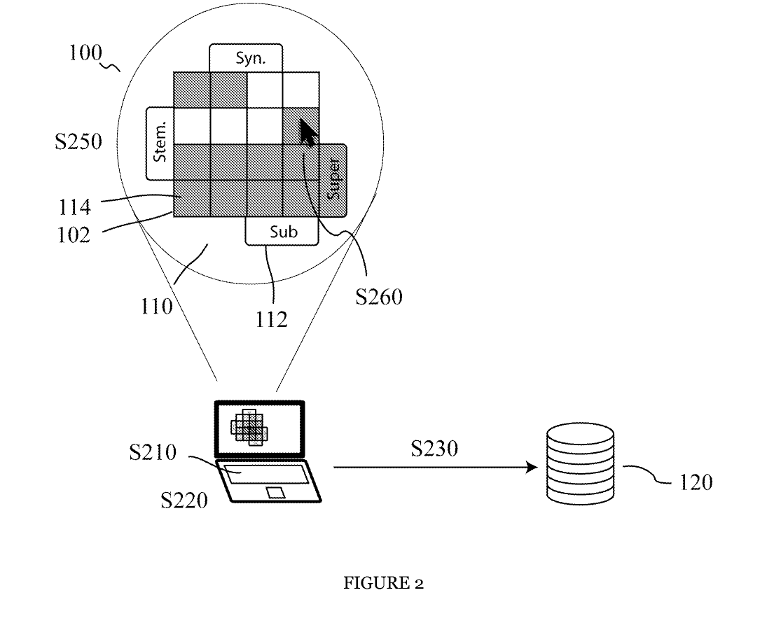

As shown in FIG. 2, the method for visualizing search specifications of the second preferred embodiment includes: obtaining a desired search query S210, preparing a collection of search strategies for a query service S220, displaying a visualization map of the search strategies associated with the collection of search strategies S250, providing an interactive capability for a graphical object S260, and submitting the selected search strategies to a query service S230. In this second preferred embodiment, the method functions to provide a visual interface for specifying a search. The method of the second preferred embodiment may alternatively be combined with the method of the first preferred embodiment to use the visualization map 100 in the specification and review process of a search. Except as noted below, Steps S210, S220, S250, S260, and S230 are substantially similar to Steps S110, S120, S150, S160, and S130, respectively.

Step S250, which includes displaying a visualization map 100 of the search strategies associated with the collection of search strategies functions to graphically represent a summary of multiple search strategies that a user can use. The visualization map 100 preferably conveys the different types of search strategies and combinations of search strategies. The visual map preferably shows each individual search strategy as a defined graphical object 102 (such as a box, circle, image, etc.). The graphical object 102 preferably indicates the type of search strategy it represents. A textual description, copy of search query that would be submitted to a query service 120, symbolic representation (such as labeling with letters or graphics), color code, organization, and/or any suitable graphical representation may be used. The visualization map 100 is preferably organized in a manner similar to a Karnaugh map used for digital logic optimization. A Karnaugh map is preferably used to show the power set of possible search strategies as seen in FIG. 3A. The core search strategies 112 are preferably used in place of the Boolean operators of a Karnaugh map. The boxes of the Karnaugh map are preferably the graphical objects 102 indicating the plurality of search strategies 110. As an additional alternative, the core search strategies 112 may be shown as tabs extending from the Karnaugh map. The visualization map 100 may alternatively be organized as a Venn diagram as shown in FIG. 3B. Each core search strategy 112 is preferably represented by a shape, and the overlapping sections of multiple shapes preferably define the graphical objects 102 representing a search strategy that is a combination of core search strategies 112. The visualization map 100 may alternatively use a tree map, a linked lattice diagram, or any suitable representation of the search results from the collection of search strategies. The visualization map 100 may alternatively be arranged or displayed in any suitable manner.

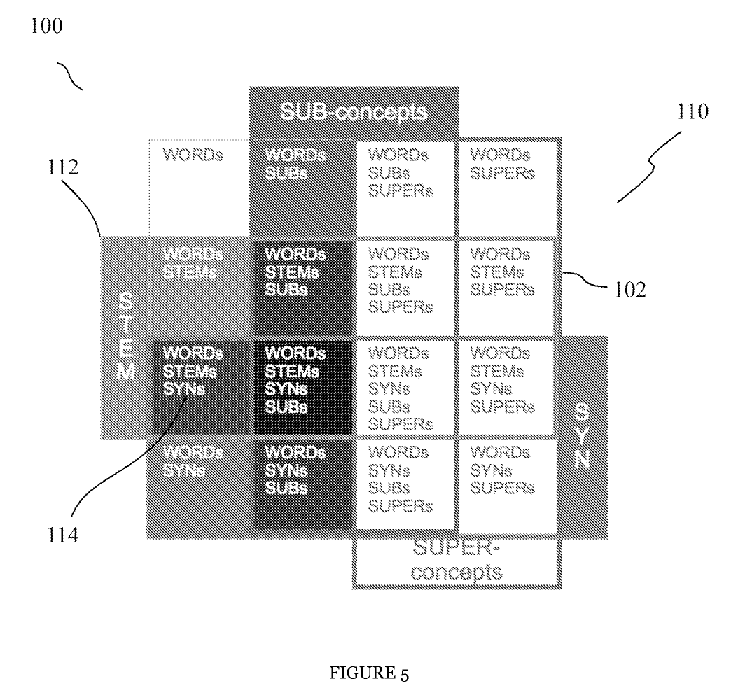

Step S260, which includes providing an interactive capability for a graphical object 102, functions to allow a user to manipulate, select, and use search strategies shown in the visualization map 100. The interactive capability preferably is a selection process by which a user can select the search strategies they wish to use in the plurality of searches submitted to the query service 120. As shown in FIG. 5, the selection process is preferably a highlighting interaction as is commonly used in computer interfaces, or individually selecting (such as by clicking on a graphical object 102 with a mouse). One variation allows a user to select all the search strategies 114 that use a particular core search strategy 112, such as by clicking on a core search strategy tab on a Karnaugh map. The interactive capability alternatively may include configuring the core search strategies 112. The configuration of the core search strategies 112 may include selecting a core search strategy 112, selecting options for a core search strategy 112, inputting information, and or any suitable steps to setup a core search strategy 112. In one example that uses sub-concept core search strategy and a super-concept core search strategy, the hierarchical level that should be searched is set by a user. During a configuration of the core search strategies 112, the visualization map 100 is preferably updated to reflect a current collection of search strategies.

Step S230, which includes submitting the selected search strategies to a query service 120, functions to send a user specified search strategies to retrieve results. Step S230 is performed in a substantially similar way as Step S130, submitting the collection of search strategies to a query service 120.

As a person skilled in the art will recognize from the previous detailed description and from the figures and claims, modifications and changes can be made to the preferred embodiments of the invention without departing from the scope of this invention defined in the following claims.

I claim:

1. A method of visually representing multiple search queries of a search service comprising the steps of:
obtaining a desired search query;
preparing a collection of search strategies for a query service, wherein the collection of search strategies includes a plurality of core search strategies for the desired search query and at least one combination of at least two core search strategies;
submitting the collection of search strategies to a query service;
receiving and processing search results from the query service; and
displaying a visualization map of the search results associated with the collection of search strategies, wherein the visualization map includes a plurality of graphical objects, wherein a graphical object of the plurality of graphical objects represents a search strategy of the collection of query strategies.

2. The method of claim 1 further including the step: providing an interactive capability for the graphical object.

3. The method of claim 2 wherein the interactive capability includes linking to a search result that relates to a query strategy.

4. The method of claim 2 wherein the interactive capabilities includes displaying search results related to a query strategy.

5. The method of claim 2 wherein the visualization map depicts a core search strategy as a shape, and the overlapping of multiple core search strategies defines regions of graphical objects.

6. The method of claim 5 wherein the collection of search strategies includes every combination of the plurality of core search strategies.

7. The method of claim 6 further including organizing the visualization map as a Karnaugh map, wherein each search strategy is represented as a variable of the Karnaugh map.

8. The method of claim 4 further including representing search result data in the visualization map.

9. The method of claim 8 wherein the search result data is presented visually by the graphical objects.

10. The method of claim 9 wherein the graphical objects present the search result data in textual form.

11. The method of claim 9 wherein the search results are represented by the size of the graphical object.

12. The method of claim 8 wherein the plurality of core search strategies includes:
a synonyms core search strategy that includes words with similar meaning to the search query;
a stemming core search strategy that includes words with the same root;
a sub-concept core search strategy that includes concepts that are lower in a hierarchical order; and
a super-concept core search strategy that includes concepts that are higher in a hierarchical order.

13. The method of claim 8 wherein at least one core search strategy uses an individual word from the desired search query.

14. A method of visually specifying a desired search of a computer system comprising the steps of:
obtaining a desired search query;
preparing a collection of search strategies for a query service wherein the collection of search strategies is composed of a plurality of core search strategies for the desired search query and at least one combination of at least two core search strategies;
displaying a visualization map of the search strategies associated with the collection of search strategies;
providing an interactive capability for search strategy manipulation;
selecting at least one search strategy with the interactive capability; and
submitting the at least one search strategy to a query service.

15. The method of claim 14 wherein the interactive capability includes providing an interface for preparing core search strategies used in the comprehensive collection of search strategies.

16. The method of claim 15 wherein the visualization map depicts a core search strategy as a shape, and the overlapping of multiple core search strategies defines regions of graphical objects.

17. The method of claim 16 wherein the collection of search strategies includes every combination of the plurality of core search strategies.

18. The method of claim 17 further including organizing the visualization map as a Karnaugh map wherein each search strategy is represented as a variable of the Karnaugh map.

19. The method of claim 18 wherein the plurality of core search strategies includes:
a synonyms core search strategy that searches for words with similar meaning to the search query;
a stemming core search strategy that searches for words with the same root;
a sub-concept core search strategy that searches for concepts that are lower in a hierarchal order; and
a super-concept core search strategy that searches for concepts that are higher in a hierarchal order.

20. The method of claim 19 wherein the step of preparing a collection of search strategies sets the hierarchical order of the sub-concept core search strategy and the super-concept core search strategy that will be searched.

21. The method of claim 18 further including the steps:
processing a search result returned by the query service; and
displaying a visualization map of the search results associated with the collection of search strategies wherein the visualization map includes a plurality of graphical objects, wherein a graphical object of the plurality of graphical objects represents a search strategy of the collection of query strategies.
